(19) United States
(12) Patent Application Publication
(10) Pub. No.: US 2015/0161539 A1
(43) Pub. Date: Jun. 11, 2015

(54) DECISION SUPPORT SYSTEM FOR PROJECT MANAGERS AND ASSOCIATED METHOD

(71) Applicant: TECHNION RESEARCH & DEVELOPMENT FOUNDATION LIMITED, Haifa (IL)

(72) Inventor: Avraham SHTUB, Haifa (IL)

(21) Appl. No.: 14/617,297

(22) Filed: Feb. 9, 2015

Related U.S. Application Data
(63) Continuation of application No. 13/943,860, filed on Jul. 17, 2013.
Application No. 13/943,860 is a continuation of application No. 13/003,544, filed on Jan. 10, 2011, now abandoned.
(60) Provisional application No. 61/078,944, filed on Jul. 8, 2008.

(51) Int. Cl. G06Q 10/06

(52) U.S. Cl. CPC G06Q 10/0637

(57) ABSTRACT

A decision support system is presented for generating data pertaining to solutions to constrained project management scenarios. The system comprises: a scenario generator for generating project management scenarios, a feasible solution generator for generating solutions to constrained project management scenarios, a scenario simulator for interactively simulating project management scenarios in a stochastic environment, and a database for storing historical data generated by the scenario simulator. Methods are presented for using the decision support system as a tutorial mechanism and as a data gathering mechanism for supporting project managers.

### CROSS REFERENCE

This application is a continuation of U.S. patent application Ser. No. 13/943,860 filed Jul. 17, 2013, which is a continuation of U.S. patent application Ser. No. 13/003,544 filed Jan. 10, 2011, which is a national phase application of PCT patent application PCT/IL09/00515 filing date May 24, 2009, which claims the priority of U.S. provisional patent 61/078,944 filed Jul. 8, 2008, all applications being incorporated herein in their entirety.

### FIELD OF THE INVENTION

The present invention relates to a decision support system for project managers. More specifically the invention relates to a system for training and supporting project managers.

### BACKGROUND

Decision support systems are important tools for the implementation of business intelligence strategy. These systems are used to support long range and short range planning and to monitor and control business processes. Successful application of business intelligence requires that historical and current data pertaining to the commercial context of a business is gathered into a repository known as a data warehouse. The contents of the data warehouse may be analyzed to make predictions regarding the probable consequences of business decisions. Decision support systems may be used to manage the data collection, analysis and presentation necessary for decision makers to make informed choices between the various options available to them. For this reason, decision support systems are particularly suited to recurring business operations, which generate multiple sets of data pertaining to repeated processes.

Unlike repetitive business processes, a project is a one-time effort to achieve a certain set of goals. Project managers are responsible for the planning, execution monitoring and control of projects. It is the role of the project manager to achieve the goals of a project within the time allotted. In doing so, the project manager must consider various other constraints such as budget, cash flow and availability of resources. Because they are one-time efforts, projects are managed with limited past information and consequently under uncertainty and risk.

A number of project management software tools are available to assist the project manager. These generally aim to generate solutions to difficult scheduling problems by using algorithms for resource leveling, resource allocation and scheduling. However, because of the one-off nature of projects, there is no historical data available for a full decision support system for project managers. Thus it is very difficult for project managers to make informed choices and as a result project failure rate is very high.

There need remains, therefore, for a decision support system for use in project management applications. Embodiments of the present invention address this need.

### SUMMARY OF THE INVENTION

Embodiments of the current invention are directed towards providing a decision support system for generating data pertaining to feasible solutions to project management scenarios. The system comprises: a scenario simulator for simulating project management scenarios in a stochastic environment, and a database for storing historical data generated by the scenario simulator. Project management scenarios typically comprise a plurality of work-packages characterized by constraints selected from the group consisting of resource constraints, human constraints, budget constraints, precedence constraints and time constraints.

Resource constraints may be characterized by probability distributions governing the value of constraint parameters. According to various embodiments, the probability distribution may be selected from the group consisting of normal distribution, triangular distribution, beta distribution, rectangular distribution and the like. Typically, the scenario simulator selects a value for each constraint parameter by using a randomized sampling method.

In preferred embodiments, the decision support system further comprises a scenario generator for generating project management scenarios. Optionally, the scenario generator may be configured for importing project management scenarios from at least one unit selected from the group consisting of: external project management support systems, a scenario library stored on the database and a user-interface receiving input from a user.

Typically, the decision support system further comprises a feasible solution generator. The feasible solution generator generally comprises an algorithm for solving project management scenarios constrained by at least one of the group consisting of resource constraints, cash constraints, time constraints and human resource constraints. Optionally, the feasible solution generator is further configured for importing feasible solutions from at least one unit selected from the group consisting of: an external project management support system, a solution library stored on the database and a user-interface receiving input from a user.

In certain embodiments of the invention, the project management scenario comprises a plurality of projects constrained by at least one of a common set of resources and a common cash flow. Optionally, the resources are selected from the group consisting of human resources, hardware, equipment, facilities, materials, inventories and budget.

Typically, the scenario simulator is operable to produce a plurality of simulations of the project management scenario. Accordingly, the database may be operable to store multiple sets of data pertaining to the plurality of simulations. Optionally, the decision support system further comprises a user-interface for presenting statistics associated with the multiple sets of data.

Preferably, the decision support system is configured to serve as a tutorial mechanism for training at least one project manager. Optionally, the decision support system is further configured to serve as a data-gathering mechanism for supporting at least one project manager.

Other embodiments of the invention are directed towards teaching a method for supporting decision making by project managers, the method comprising the steps: step (a)—generating at least one project management scenario; step (b)—obtaining at least one feasible solution to the project management scenario; step (c)—simulating the feasible solution in a stochastic environment, and step (d)—storing in a database historical data generated by the simulation of the feasible solution. Typically, step (c) and step (d) are repeated. Optionally the method comprises the additional steps: step (e1)—presenting a status of the feasible solution to a user, and step (e2)—the user editing the feasible solution.

According to various embodiments step (b) of obtaining at least one feasible solution to the project management scenario may comprise obtaining at least one work-package characterized by constraints selected from the group consisting of resource constraints, budget and time.

Typically, the step (c) of simulating the feasible solution in a stochastic environment comprises the substeps of: step (c1)—defining a probability distribution governing availability of at least one resource, and step (c2)—selecting a value for availability of the resource using a randomized sampling method based upon the probability distribution. Optionally, step (c2) is repeated to produce a plurality of values for availability of the resource.

The method of claim 24 further comprising additional steps: step (f)—analyzing historical data pertaining to at least one feasible solution, and step (g)—presenting an analysis of the historical data to a user.

### BRIEF DESCRIPTION OF THE FIGURES

For a better understanding of the invention and to show how it may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention; the description taken with the drawings making apparent to those skilled in the art how the several forms of the invention may be embodied in practice. In the accompanying drawings:

FIG. 1 is a block diagram showing the main elements of a decision support system for project management according to an exemplary embodiment of the invention;

FIGS. 2a and 2b show block diagrams representing two embodiments of the decision support system integrated into multi-project collocated or distributed environments;

FIG. 3 shows a flowchart representing a method for supporting decision making by project managers according to another embodiment of the invention;

FIG. 4 is a flowchart showing how the decision support system is used as a tutorial mechanism according to a further embodiment of the invention, and

FIG. 5 is a flowchart showing how the decision support system is used as a data-gathering mechanism according to still another embodiment of the invention.

### DESCRIPTION OF THE PREFERRED EMBODIMENTS

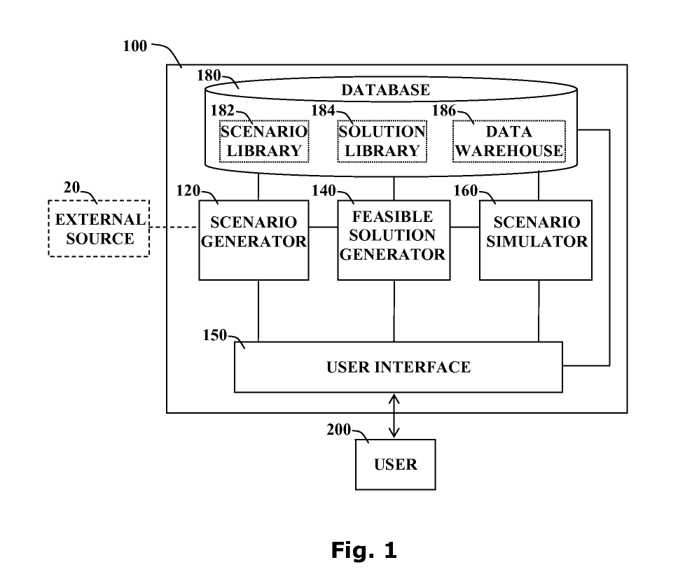

Reference is now made to FIG. 1 showing a block diagram representing the main elements of a decision support system 100 for project management according to an exemplary embodiment of the invention. Embodiments of the decision support system 100 provide a tutorial mechanism for training project managers and project teams as well as a data collection mechanism for gathering data pertaining to feasible solutions to project management scenarios. Consequently the decision support system 100 may serve as a single tool for supporting project managers at all levels from complete novice to experienced expert.

The exemplary decision support system 100 includes a scenario generator 120, a feasible solution generator 140, a scenario simulator 160, and a database 180. A particular feature of embodiments of the present invention is that the decision support system 100 is interactive. A user-interface 150 is provided via which a user 200 receives feedback from and interacts with the various components 120, 140, 160, 180 of the decision support system 100.

The scenario generator 120 provides real or virtual project scenarios. Project scenarios typically include an overall set of goals to be completed by a due-date and within a given budget. Preferably, project scenarios generated by the scenario generator are further characterized by other constraints such as precedence constraints among project activities, limited human or other resources and the like.

According to some embodiments, the details of project scenarios may be built by the scenario generator 120 itself. Alternatively, project scenarios may be imported from external project management support systems 20, such as Microsoft Project, Primavera Project Planner, Sciforma PSNext and the like. Typically, the generated project scenario may be further edited by the user 200 via the user-interface 150.

Optionally project scenarios may be retrieved from a library 182 of pre-prepared project scenarios stored in the database 180. This feature may be particularly useful when the decision support system 100 is being used in tutorial mode. For example, a novice project manager may be presented with project scenarios selected to illustrate various teaching points.

Generally, a project scenario is made up from a plurality of work-packages each having its own targets and allotment of resources. It is a particular feature of embodiments of the present invention that the feasible solution generator 140 may use algorithms for solving project management problems to produce suitable workplans for carrying out all the work-packages making up a project scenario. The term ‘feasible solution’ is used herein to refer to workplan solutions which solve project scenarios without infringing resource, cash flow, precedence or other constraints.

Optionally, solution generating algorithms use a model-based approach using a variety of project management concepts. The model-base, used by the feasible solution generator 140 may include models for tasks such as scheduling, budgeting, resource management, monitoring and control.

Feasible solutions may be presented to the user 200 via the user-interface 150. The user 200 is then able to access the system-generated feasible solution as a “best practice” reference. Such a reference may serve as an editable template for the user 200. The user 200 may choose to edit the system-generated feasible solution via the user-interface 150. Thus, embodiments of the feasible solution generator 140 integrate the computer's ability to find good solutions to project scenarios with the human ability to use fuzzy logic, experience and intuition.

In preferred embodiments of the invention, the feasible solution generator further stores solutions in a solution library 184 in the database 180. Stored solutions may be retrieved from the database 180 when needed, for example, for statistical analysis, reference or simulation.

The feasible solution is typically transferred to the scenario simulator 160 for simulation in a stochastic environment. The scenario simulator 160 is operable to receive at least one project scenario consisting of one or more work-packages. Each work-package is typically characterized by a number of attributes including required resources. The scenario simulator 160 typically uses a dynamic approach in which the situation changes over time, reflecting the uncertainty of real life scenarios. To this end, the scenario simulator 160 introduces random effects into the simulation. Preferably, the scenario simulator 160 may be configured to run the simulation for a run period of duration determined by the user 200.

During the simulation, the scenario simulator 160 determines the actual availability of resources, the actual duration of activities and the like, by random selection based upon a probability distribution. The probability of resource availability, activity duration and the like are characteristic of the project management scenario and may be set automatically by the scenario generator 120 or manually by the user 200 via the user-interface 150. Probability may be defined by variables such as mean values, range values and distribution type. The probabilistic distribution may be for example triangular, normal, beta, rectangular or the like. Furthermore, the changing state of the model being simulated may be presented to the user via the user-interface 150 and the user 200 may interact with the scenario simulator 160 making changes to the state of the project scenario during simulation.

It is a particular feature of embodiments of the current invention that the changing state of the project scenario may be stored in the database 180 during the simulation. This functionality provides a set of historical data 186 which may be used to return the scenario under simulation to a previous state. Optionally, the user 200 may rerun the scenario simulator 160 using the previous state from that historical point. Alternatively, the user 200 may make adjustments to the project workplan, using the feasible solution generator 140 or using the user-interface 150. The scenario simulator 160 may rerun the scenario from that historical point with the new workplan. Furthermore historical data stored in the database 180 is readily available to the user 200 to support decision making

The decision support system 100 of the invention may be distinguished from prior art add-on tools for project management systems, such as “Risk” and “Crystal Ball”. Although these tools may simulate certain solutions, they do not provide mechanisms for further input from the user 200 during the simulation process. In contradistinction to prior art, the user-interface 150 and historical database 180 of embodiments of the current invention allow the user 200 to interact with a running project simulation and to change past decisions during the simulation based on user experience in combination with computerized support tools.

It is noted that in some embodiments, the storage of historical data may be optional. This feature may be particularly useful when the decision support system is used as a tutorial mechanism. By removing the perceived safety net of the automatic undo-functionality associated with stored historical data, a novice user is encouraged to develop greater awareness of project management trends, pitfalls and best practice. The novice may be prompted to save the history actively if they consider it necessary.

Where the decision support system is used as a decision collection mechanism, preferably, the decision support system 100, is capable of producing multiple sets of data pertaining to a single project scenario. Such data may be used to compile a data warehouse 186 for use in making predictions regarding the likely outcomes of given project management strategies.

Typically, the scenario simulator 160 is operable to produce a plurality of simulations from the given project management strategy. Because the scenario simulator 160 runs simulations in a stochastic environment, multiple simulations of a common project management scenario do not generally produce identical results. The database 180 may be configured to store multiple sets of results generated by multiple simulations of the same project scenario. The user 200 may access this data via the user-interface 150. Preferably characteristic statistics of the multiple sets of results are presented to the user 200 via the user-interface 150. This statistical data may be used to assist with project management decision making Note also that although a decision support system 100 having a single database 180 is described herein, in other embodiments a plurality of databases 180 may be preferred.

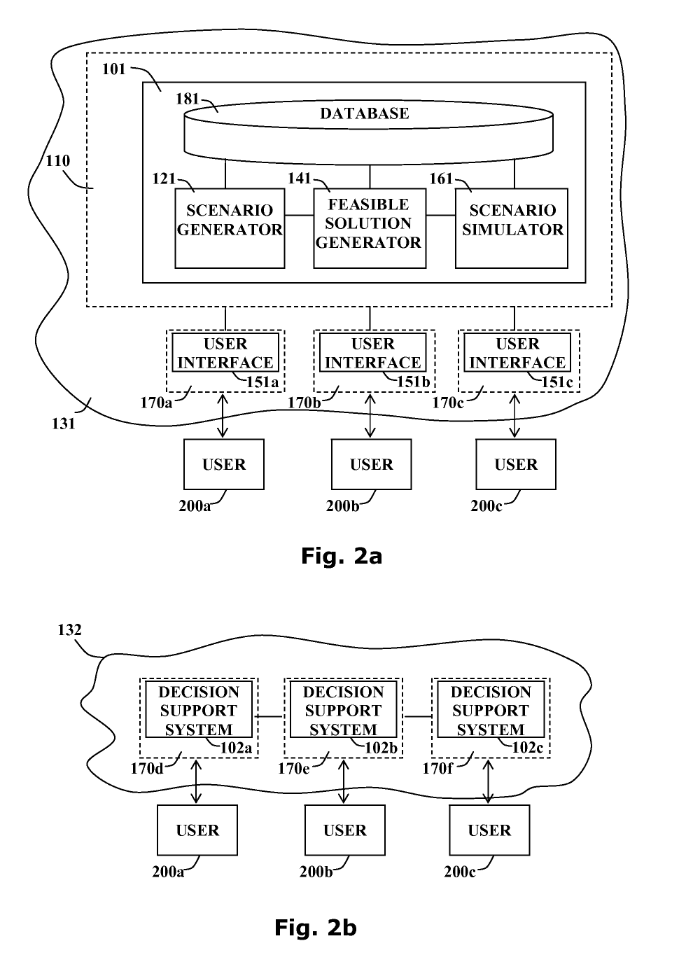

Reference is now made to FIGS. 2a and 2b showing block diagrams representing how decision support systems 101, 102 may be integrated into a multi-project environment according to other embodiments of the invention. Many organizations rely on resource sharing across multiple projects. Unlike work-packages within a single project, multiple projects do not typically share their project objectives, budgets or time frames and are generally managed by separate project managers. The projects within a multi-project environment may however generally share a common set of resources and sometimes a common cash flow.

It will be appreciated that embodiments of the current invention, in which the feasible solution generator 161 uses algorithms that solves the project planning problem under a variety of constraints such as resource constraints, cash flow constraints, budget constraints, due date or time constraints and the like, are particularly suited to training project managers in multi-project environments. Referring to FIG. 2a, a central server 110 of an organization is connected to multiple computer terminals 170a-c via a network 131 such as a local area network or via the web, for example. A common decision support system 101 is configured to communicate with multiple user-interfaces 151a-c each running on an individual terminal 170a-c. Separate users 200a-c may individually interact with the common decision support system 101. The feasible solution generator 141 and scenario simulator 161 are configured to share the available resources between the various projects according to each project's resource requirements.

An alternative configuration is shown in FIG. 2b in which stand-alone decision support systems 102a-c are running on separate computer terminals 170d-f connected by a network 132 such as a local area network or via the web, for example. The individual decision support systems 102a-c are configured to communicate resource requirements of each project so that feasible project solutions, which are proposed, take into account the resource requirements of all parallel projects.

As with other embodiments of the invention, multi-project decision support systems 101, 102 may be used as tutorial mechanisms and as data-gathering mechanisms. Such systems are particularly useful in matrix structure organizations in which project managers working in parallel hierarchical structures may need to share common resources or common cash flows. It will be appreciated that the tutorial mechanism may be of use in fostering a team-like working relationship between competing project managers in such an organization. Distributed project teams, which are not collocated at a common site, may prefer to use the system via the web to practice teamwork, communication and to perform project debriefing at the end of a project or a stage of a project as part of Root Cause Analysis (RCA) of the project's results, for example.

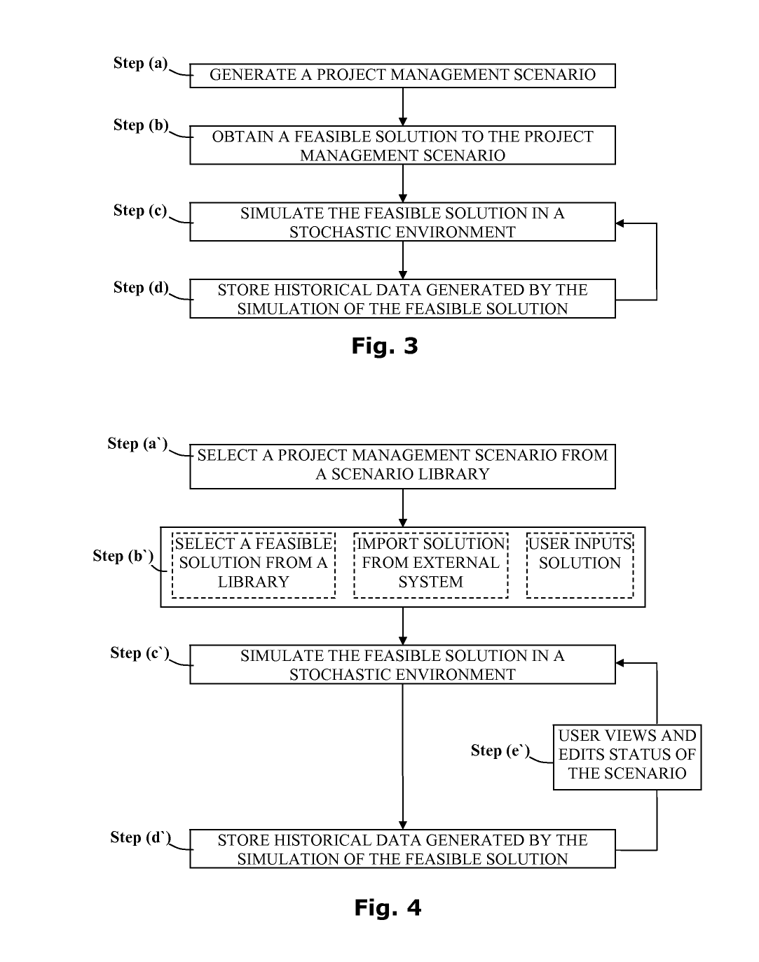

Reference is now made to FIG. 3 showing a flowchart representing a method for supporting decision making by project managers using decision support systems according to various embodiments of the invention. The method includes the following steps: step (a)—generating a project management scenario, step (b)—obtaining a feasible solution to the project management scenario; step (c)—simulating the feasible solution in a stochastic environment, and step (d)—storing historical data generated by the simulation of the feasible solution. Typically, step (c) and step (d) are repeated a number of times.

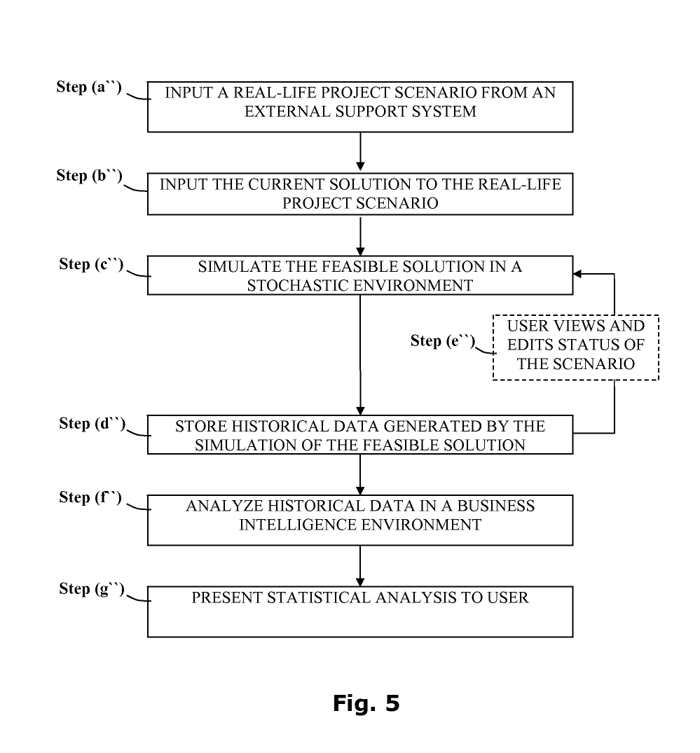

FIG. 4 shows a flowchart representing a method for using the decision support system as a tutorial mechanism, according to further embodiments of the invention. The method involves the following steps:

Step (a′)—a project scenario is selected from a library 182 (FIG. 1) of scenarios stored on a database 180 (FIG. 1). Preferably, the project scenario includes all details needed to decide an operational mode for each task, including the start time and number of resource units required.

Step (b′)—a plan is generated for carrying out the project scenario. The plan may be produced automatically by the feasible solution generator 140 of the decision support system 100. Alternatively a solution may be selected from a library 184 of solutions stored on the database 180, imported from an external project management system 20 or using some other algorithm. Preferably, the user may also edit computer generated plans to suit requirements.

Step (c′)—the proposed plan is simulated by the system. Preferably, the user may define a certain run-period and the simulation will runs for the duration of the run-period during which values for the actual duration of each activity and the actual availability of each resource are selected by the simulator.

Step (d′)—the status of the plan after the run-period is stored in a historical database.

According to preferred tutorial mechanisms, the user may access the status of the project at the end of the run-period and make changes to the plan—step (e′). For example the user may reschedule tasks, hire additional resources or change the mode of operation of future tasks. Note that the user may use the feasible solution generator or any other support system to make such changes to the plan. Usefully, steps (c′) and (d′) are repeated any number of times by rerunning the simulator either from the point at which the run-period ended or alternatively by returning to some previous historical point stored in the historical database and rerunning the simulator from that point. In this way, the user may run the simulation from the same historical point using different plans. It will be apparent that with such a tutorial mechanism a user may learn from past results stored in the historical database.

Note that this tutorial mechanism is in contradistinction to current training practice for project managers. Traditionally, the training of new project managers has relied heavily upon the trainee gaining real on-the-job experience. Acquiring PMP (Project Management Institute) accreditation, for example, requires both passing an exam and accumulating enough on-the-job experience in project management.

It is the nature of on-the-job training that the trainee typically makes many mistakes and learns from them. The mistakes of a project manager can be extremely costly and therefore on-the-job training of project managers can be very expensive and/or time consuming. As the management of time and cost constraints are crucial to the success of projects, it is important to save the time and cost of on-the-job training It will be appreciated that tutorial mechanisms using embodiments of the decision support system 100 described herein provide a workable alternative to traditional on-the-job training

Furthermore embodiments of the invention support project managers from the early training stage in their career development throughout their entire career. In the early training stage novice project managers can learn the techniques of project management by simulating progressively more difficult scenarios. The model base according to various embodiments supports decisions regarding scheduling, budgeting cash flow management, risk management and monitoring and control. The history mechanism supports debriefing and analysis of past performances as part of the learning session. As knowledge is accumulated more difficult scenarios are simulated for example including multi-user and multi-project scenarios. These scenarios are managed using the feasible solution generator 160 which generates solutions to support decision making

Note that optionally, external project management systems as known in the art may be integrated into the training in order to develop an understanding of how such software may be used on the simulated scenarios.

Alongside the tutorial mechanism, embodiments of the decision support system 100 further assist in the decision making of real-life projects by performing “what if” analysis. Thus the simulator may be used to simulate a number of suggested solutions under dynamic stochastic conditions and the data-gathering mechanism may be used to analyze the results of these simulations.

FIG. 5 is a flowchart representing a method for using the decision support system 100 (FIG. 1) as a data-gathering mechanism according to still another embodiment of the invention. The method involves the following steps:

Step (a″)—a real-life project scenario is imported by the scenario generator 120 from external project management system 20. Alternatively a user may enter the scenario manually via the user-interface 150.

Step (b″)—a current project plan may be entered into the feasible solution generator 140 manually via the user-interface 150. Alternatively, a new solution may be generated and edited as necessary.

Step (c″)—the plan may be simulated by the scenario simulator 160 for a first run period with values for the actual duration of each activity and the actual availability of each resource being selected by the simulator.

Step (d″)—the status of the plan after the run-period is stored in a historical database 180.

Steps (c″) and (d″) are repeated multiple times in a stochastic environment thereby gathering multiple sets of historical data pertaining to each plan.

Step (f″)—the historical data may be analyzed using business intelligence techniques either automatically using business intelligence analysis systems or by the user.

Step (g″)—the statistical analysis may be presented to the user via the user interface.

Optionally, the user is able to step through the simulation with the user being able to change the plan after a certain number of iterations of steps (c″) and (d″). For example the user may choose to reschedule tasks, hire resources or change the mode of operation of future tasks, after any number of iterations. The user may go back in time using the history mechanism and restart the simulation from any point in the past that was saved as history. Thus the user may run the same scenario a number of times trying different plans and using the results to analyze the pros and cons of each possible plan. At the end of the process the user may select the most appropriate plan and develop a risk management plan for the project based on the results obtained from the simulation runs.

Thus embodiments of the invention provide a support system for project management which may be used as both a tutorial mechanism and a data-gathering mechanism for generating statistics useful to business intelligence analysis. It is noted that a single tool may be used to support project managers from the novice to the expert levels.

The scope of the present invention is defined by the appended claims and includes both combinations and sub combinations of the various features described hereinabove as well as variations and modifications thereof, which would occur to persons skilled in the art upon reading the foregoing description.

In the claims, the word “comprise”, and variations thereof such as “comprises”, “comprising” and the like indicate that the components listed are included, but not generally to the exclusion of other components.

1. A decision support system for generating data pertaining to feasible solutions to project management scenarios, said system comprising:
a scenario simulator for simulating project management scenarios in a stochastic environment, and
a database for storing historical data generated by said scenario simulator.

2. The decision support system of claim 1 wherein said project management scenarios comprise a plurality of work-packages characterized by constraints selected from the group consisting of resource constraints, budget constraints, precedence constraints and time constraints.

3. The decision support system of claim 2 wherein said resource constraints comprise human resources.

4. The decision support system of claim 2 wherein said constraints are characterized by probability distributions governing the value of constraint parameters.

5. The decision support system of claim 4 wherein said distribution is selected from the group consisting of normal distribution, triangular distribution, beta distribution and rectangular distribution.

6. The decision support system of claim 4 wherein said scenario simulator selects a value for each constraint parameter by using a randomized sampling method.

7. The decision support system of claim 1 further comprising a scenario generator for generating project management scenarios.

8. The decision support system of claim 7, said scenario generator for importing project management scenarios from at least one unit selected from the group consisting of: external project management support systems, a scenario library stored on said database and a user-interface receiving input from a user.

9. The decision support system of claim 1 further comprising a feasible solution generator.

10. The decision support system of claim 9 wherein said feasible solution generator comprises an algorithm for solving project management scenarios constrained by at least one of the group consisting of resource constraints, cash constraints, time constraints and human resource constraints.

11. The decision support system of claim 9, said feasible solution generator for importing feasible solutions from at least one unit selected from the group consisting of: an external project management support system, a solution library stored on said database and a user-interface receiving input from a user.

12. The decision support system of claim 1, wherein at least one said project management scenario comprises a plurality of projects constrained by at least one of a common set of resources and a common cash flow.

13. The decision support system of claim 12 wherein said resources are selected from the group consisting of human resources, hardware, equipment, facilities, materials, inventories and budget.

14. The decision support system of claim 1, said scenario simulator being operable to produce a plurality of simulations of said project management scenario.

15. The decision support system of claim 14, said database being operable to store multiple sets of data pertaining to said plurality of simulations.

16. The decision support system of claim 15 further comprising a user-interface for presenting statistics associated with said multiple sets of data.

17. The decision support system of claim 1 configured to serve as a tutorial mechanism for training at least one project manager.

18. The decision support system of claim 17 further configured to serve as a data-gathering mechanism for supporting at least one project manager.

19. A method for supporting decision making by project managers, said method comprising the steps:
step (a)—generating at least one project management scenario;
step (b)—obtaining at least one feasible solution to said project management scenario;
step (c)—simulating said feasible solution in a stochastic environment, and
step (d)—storing in a database historical data generated by the simulation of said feasible solution.

20. The method of claim 19 wherein step (c) and step (d) are repeated.

21. The method of claim 20 further comprising additional steps:
step (e1)—presenting a status of said feasible solution to a user, and
step (e2)—said user editing said feasible solution. are introduced after step (d).

22. The method of claim 19 wherein said step (b) of obtaining at least one feasible solution to said project management scenario comprises obtaining at least one work-package characterized by constraints selected from the group consisting of resource constraints, budget and time.

23. The method of claim 19 wherein said step (c) of simulating said feasible solution in a stochastic environment comprises the substeps of:
step (c1)—defining a probability distribution governing availability of at least one resource, and
step (c2)—selecting a value for availability of said resource using a randomized sampling method based upon said probability distribution.

24. The method of claim 23 wherein said step (c2) is repeated to produce a plurality of values for availability of said resource.

25. The method of claim 24 further comprising additional steps:
step (f)—analyzing historical data pertaining to at least one feasible solution, and
step (g)—presenting an analysis of said historical data to a user.
